(19) United States
(12) Patent Application Publication
(10) Pub. No.: US 2003/0074358 A1
(43) Pub. Date: Apr. 17, 2003

(54) Integration, management and processing of network data from disparate sources

(76) Inventors: Siamak Sarbaz, London (GB); Philippe Bonneau, Paris (FR); Youri Canetti, Paris (FR); Hugues Bouclier, Paris (FR); Anthony Saugeron, Paris (FR); Vincent Gautier, Paris (FR); David Tavoularis, Paris (FR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/962,968

(22) Filed: Sep. 24, 2001

(51) Int. Cl. G06F 7/00

(52) U.S. Cl. 707/10

(57) ABSTRACT

A layered architecture for a network information management system integrates data about the network supplied by disparate sources, each specific to network equipment from a particular vendor, by mapping the data into a common data model that represents a unified view of the network. The data is stored into a storage structure based on characteristics of the data and the data in the storage structure is subsequently correlated into information pertaining to the unified view of network. The information is presented to a user in various formats. The network information management system can further perform a knowledge analysis on the information to evaluate the network, detect problems in the network, and to suggest solutions to any problems detected. The knowledge analysis is based on a knowledge scenario that relates the information with an analysis process that performs the analysis.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 1996, Mycom International, All Rights Reserved.

### FIELD OF THE INVENTION

This invention relates generally to networks of dissimilar equipment, and more particularly to integration, management and processing of data from disparate sources within the network.

### BACKGROUND OF THE INVENTION

The infrastructure of complex networks, such as those for telecommunications and transportation routing, presents a management challenge because the infrastructure is typically a combination of different equipment from multiple vendors. Moreover, rapid change in the underlying technology requires constant updating of the infrastructure, leading to high operating costs and introducing potential errors into the network. Detecting the errors and monitoring the general operation of the network is difficult because the tools provided by a vendor are specific to its hardware and are usually based on a proprietary view of the network. Thus, network support personnel must be trained to use the different tools and to relate the data output by one tool for one portion of the network with the data output by another tool for yet another portion of the network. These training costs further contribute to the high operating costs of the network, particularly when there is rapid turnover in the support staff. Additionally, analysis of prospective changes in the network is rendered almost impossible when the changes involve equipment from multiple vendors. Furthermore, the vast amount of data from somewhat unconnected equipments does not lend itself easily to identifying the problems of the network and thereby finding a satisfactory resolution to those problems, causing financial losses to the operators as well as bad quality of service for the users. Moreover, the hidden relations between events occurring across the network cannot easily be identified again, causing large losses in terms of lost opportunities for the operators.

### SUMMARY OF THE INVENTION

A layered architecture for a network information management system integrates data about the network supplied by disparate sources, each specific to network equipment from a particular vendor. The network information management system imports the data from the disparate sources, maps the data into a common data model that represents a unified view of the network, stores the data from the common data model into a storage structure based on characteristics of the data, correlates the data in the storage structure to produce information about the unified view of the network and presents the information in formats that enables a user to examine the network as a whole, regardless of the particulars of the underlying hardware and technologies of the network infrastructure. The network information management system can further perform a knowledge analysis on the information to evaluate the operation of the network, to detect problems in the network, and to suggest solutions to any problems detected. The knowledge analysis is based on a knowledge scenario that relates the information with an analysis process that performs the analysis on the information. Because the user is presented with a unified view of the network, management of the network is simplified, leading to reduced operating costs. Additionally, the knowledge scenarios can be used to perform “what-if” analysis on potential changes in the network. Furthermore, new opportunities and services can be provided by the network operators to their customers, enhancing the ratio of infrastructure expenditure to value add for the customers as well as efficiency of the operators in terms of introduction of personalized services

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a diagram illustrating a layered architecture for an embodiment of the invention;

FIG. 2 is a diagram illustrating a computerized system operating according to the layered architecture of FIG. 1;

FIGS. 3 and 4 are diagrams illustrating a particular embodiment of the system of FIG. 2;

FIG. 5 is a diagram of a data storage structure for use in the embodiment shown in FIG. 3;

FIG. 6 is a diagram of a scenario library data structure for use in the embodiment shown in FIG. 3;

FIGS. 7-10 are flowchart of methods to be performed by a computer in the embodiment shown in FIG. 3;

FIG. 11A is a diagram of one embodiment of an operating environment suitable for practicing the present invention; and

FIG. 11B is a diagram of one embodiment of a computer system suitable for use in the operating environment of FIG. 11A.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

The detailed description is divided into four sections and a conclusion. In the first section, a system level overview of the invention is presented. In the second section, details of processing modules and logical structures for a particular embodiment of the invention are described. The third section presents methods to be performed by the processing modules to implement the operation of the invention. In the fourth section, an operating environment in conjunction with which embodiments of the invention may be practiced is presented.

### System Level Overview

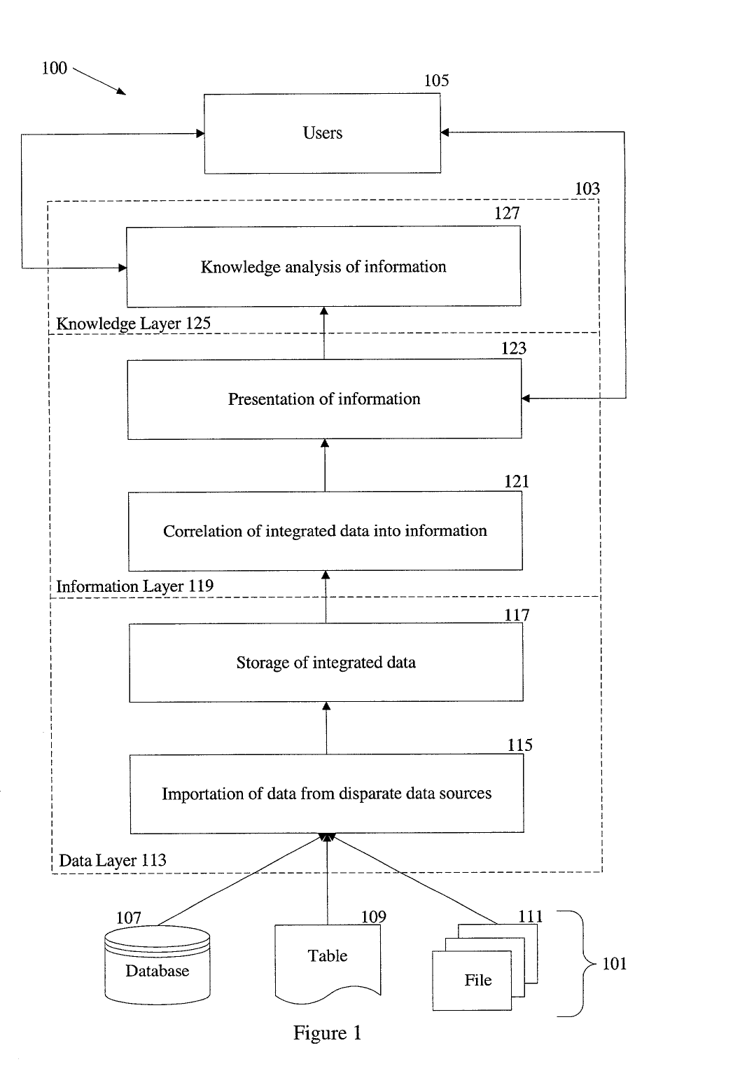

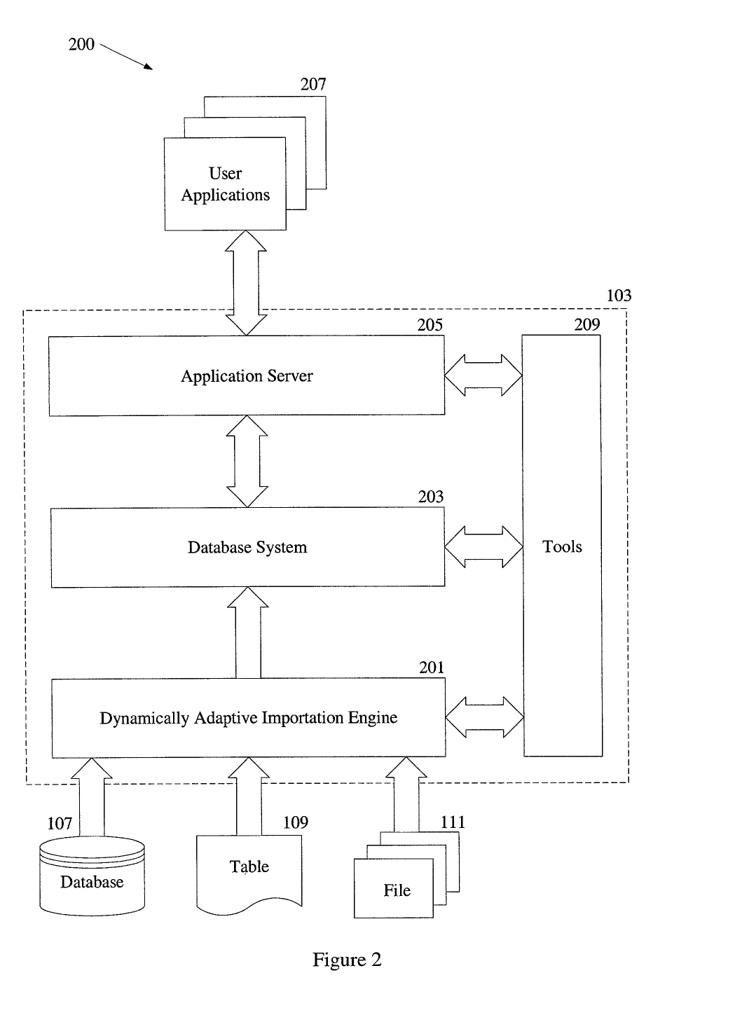

A system level overview of an embodiment of the invention is described by reference to FIGS. 1 and 2. FIG. 1 illustrates a logical view 100 of a layered architecture for a system 103 that integrates, manages and processes data pertaining to a non-homogeneous network or networks, such as logistical or communication networks, from multiple, diverse data sources 101 to present information and knowledge derived from the data to users 105. Exemplary input data sources 101 include a database 107, such as a relational database, a table 109, such as a spreadsheet, and a set of files 111, such as a comma-delimited flat file, but the invention is not limited by these examples.

Each layer in the architecture performs certain processing to refine the input data into the information and knowledge that can be readily understood by the user. Because the elements of the network may be from multiple vendors that provide differing types of data, and because the data sources 101 may represent the output of a variety of dissimilar network tools, a data layer 113 imports 115 the data and stores it 117 in an integrated format to allow unified processing of the data by the other layers, regardless of the origin of the data. At an information layer 119, the integrated data is correlated 121 to create information encompassing all the elements in the network that is presented 123 to the users 105 through visualizations or reports. At a knowledge layer 125, the users 105 can initiate knowledge analysis 127 on the information that informs of problems in the network, instructs on possible solutions to these problems, and optionally automatically changes parameters in the network configuration to achieve a solution. The knowledge layer 125 may also provide the user with the facility to look at different possibilities based on analysis of available data and potential inter-relationships in order to create new services.

FIG. 2 illustrates one embodiment of a computerized system 200 that incorporates the layered architecture 100 of FIG. 1. The processing at the data layer 113 is performed by a dynamically adaptive importation engine (DAIE) 201 and a database system 203. The DAIE 201 identifies the semantics of the incoming data, integrates the data from the diverse data sources 101 into a common data model, performs statistical analysis of the data, and updates a network database within the database system 203. In one embodiment, an importation and configuration manager graphical user interface (GUI) is used to control the behavior of the DAIE 201.

The DAIE 201 can further include a scheduler that retrieves data from the data sources 101 at user-specified intervals. If the DAIE 201 determines data is missing, it can notify the user of a problem during processing, and has a retry mechanism to cope with temporary unavailability of data. The database system 203 is capable of storing various types of data, including character, multi-media, and numeric information, and maintains historical data to enable analysis of changes in the network. Some of the data may represent geographical coordinate data for the network elements.

The processing for the information 119 and knowledge 125 layers is performed by an application server 205. The application server 205 correlates the data stored in the database system 203 to present information about the network through a GUI. In one exemplary embodiment, a GIS (geographic information system) component creates a graphical, geographic-based visualization, converting between coordinate systems when necessary, and handles special queries such as “display all network elements within N miles of the selected point.” The GUI allows the user to select a location on the visualization and “drill-down” to the lowest network entity to retrieve data about that target entity from the database system 203. The data may include video and/or audio data from cameras or microphone sources located at, or near, the target entity. Because the data is integrated in the database system 203, data for network entities from different vendors can be presented in the same visualization. For example, in a wireless telecom network, the user may wish to see the routing of a telephone call as the mobile handset travels between cells in the network. Using the visualization, the user can view the details for any of the points on the route even though the call is being handled by cell controllers from different vendors. By correlating data from different vendors, the application server 205 combines data previously only accessible through vertical, i.e., vendor-specific, tools into an integrated, horizontal view of the overall network. Furthermore, the application server 205 can correlate data between network changes because of the historical data maintained by the database system 203, thus supporting network flexibility.

As part of the information layer 119, the application server 205 also provides a library of report templates that can be manipulated by the users through a correlation report builder (part of tools 209) to rapidly build multi-dimensional reports of particular “shapes” using the data in the database system 203. The reports can be textual or graphical in nature.

When the user initiates a knowledge analysis of a report, the application server 205 provides a textual, e.g., HTML-formatted, explanation of how to analyze the report and what kind of conclusions can be drawn from the report. The application server 205 maintains an associated between reports and a library of “scenarios.” Upon initiation, the knowledge analysis executes a scenario that identifies a problem in the reported data and produces a series of suggestions based on the problem data. If the user selects one of the suggestions, the knowledge analysis present a new report following up the problems with additional data, and presents further suggestions. This process continues until the knowledge analysis suggests that a physical change is required or, optionally, automatically performs the changes necessary to resolve a particular problem. The user can elect to discontinue the knowledge analysis at any point in the process. For example, an expert user may only need to see the initial knowledge analysis to understand what changes need to be made to the network, while a neophyte user may need to be instructed on the exact change that is necessary. Because one report in the scenario may require data from data from the vertical tools for vendors A and B, while a later report in the same scenario may require data from the vertical tools for vendors A and C, the knowledge analysis relies on the correlation of the data at the information layer 119.

In addition to the correlation report builder previously described, the tools 209 include a scenario builder that allows the user to configure or create new scenarios and associate them with certain reports, a formula editor that specifies how to aggregate and de-aggregate data, and perform other mathematical operations to produce values at a different granularity than the granularity at which the data was stored, and a data model configurator used to add, delete and/or modify the semantics of the data for the common data model.

The system level overview of the operation of an embodiment of the invention has been described in this section of the detailed description. A layered architecture imports data from disparate sources, maps the data into a common data model, and stores the data in the common data model in storage structures. The stored data is subsequently correlated into a cohesive presentation of information about the network that extends across vendor, equipment, and technology boundaries. The network information can be further refined to provide solutions to network problems using a knowledge-based process. While the invention is not limited to any particular arrangement of components, for sake of clarity a simplified computerized system that incorporates the layer architecture has been described.

### Structural Details

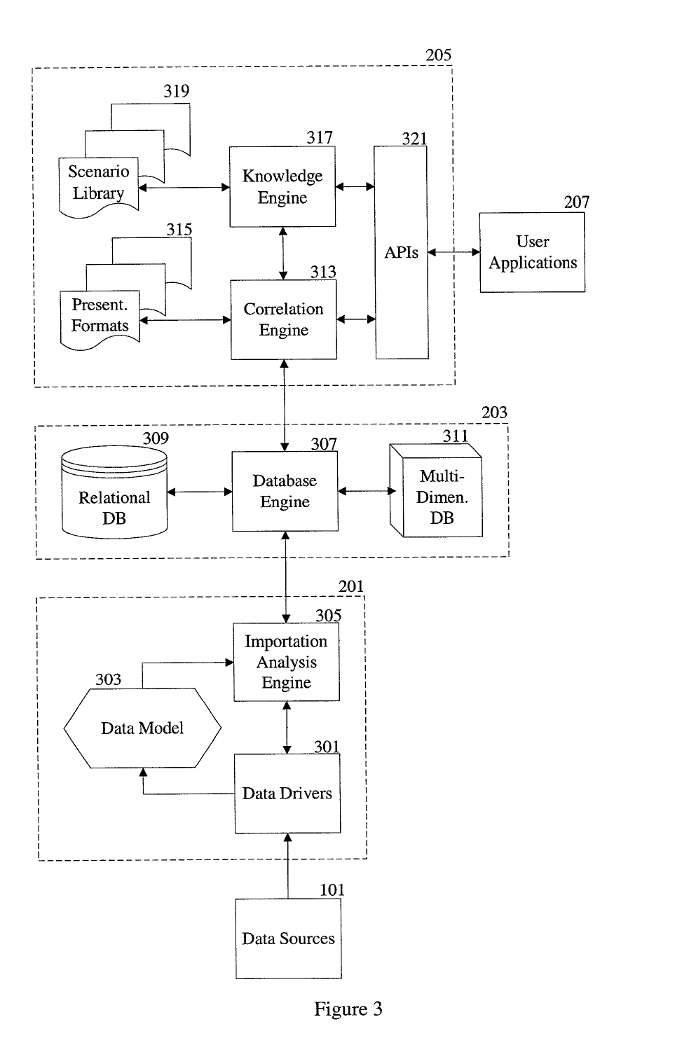

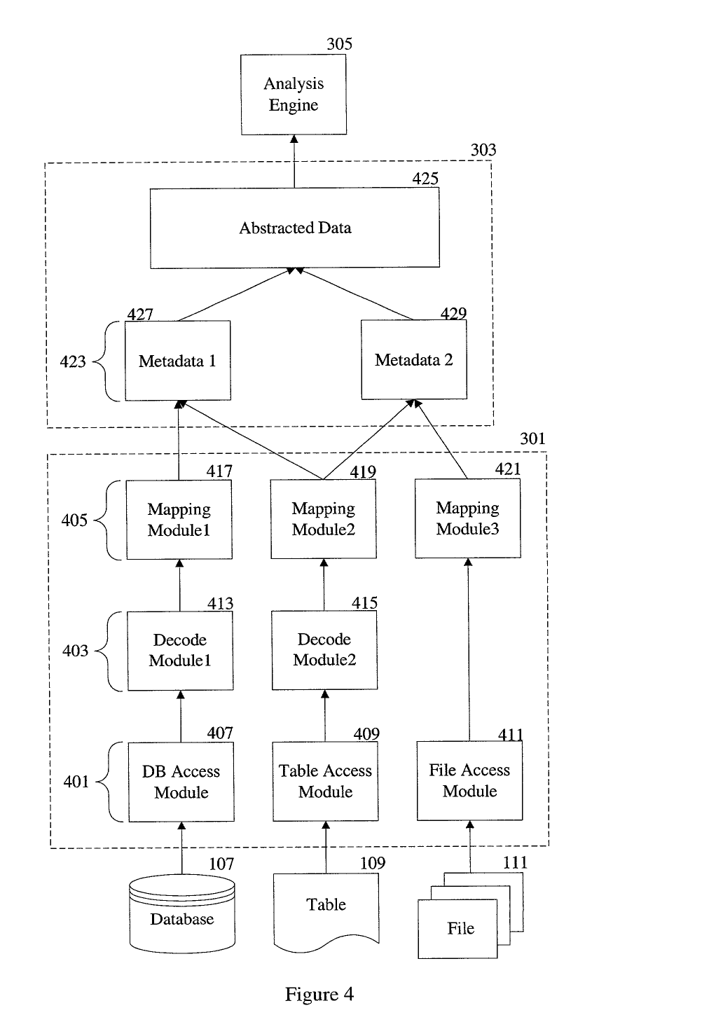

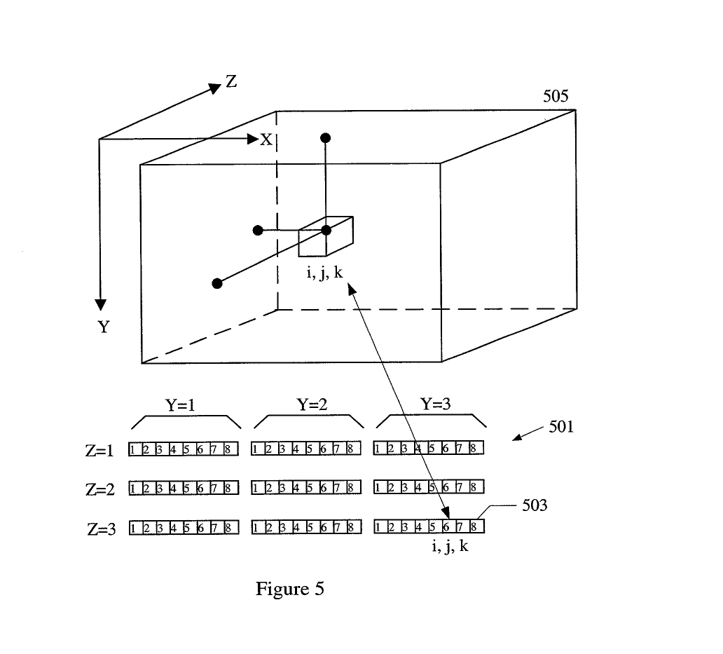

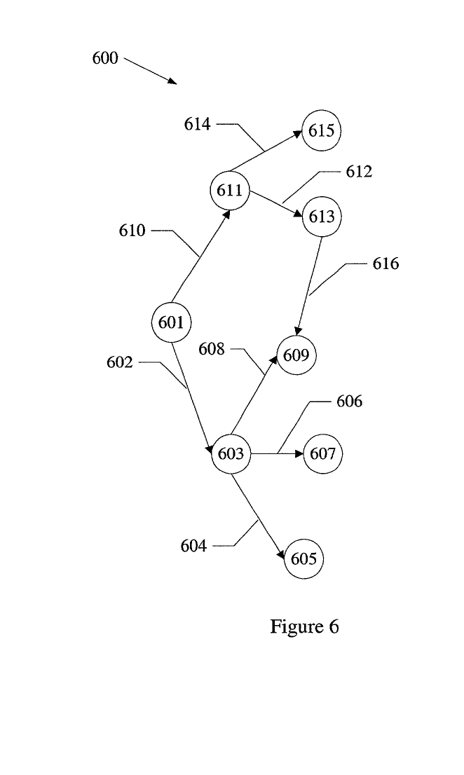

The details of processing modules and logical structures for one embodiments of the invention are now described with reference to FIGS. 3, 4, 5 and 6. FIG. 3 illustrates a particular arrangement of components, such as software modules, that perform the operations of the invention. The components for the DAIE 201 are further detailed in FIG. 4. Exemplary data structures for the network database and the scenario library are illustrated in FIG. 5 and 6.

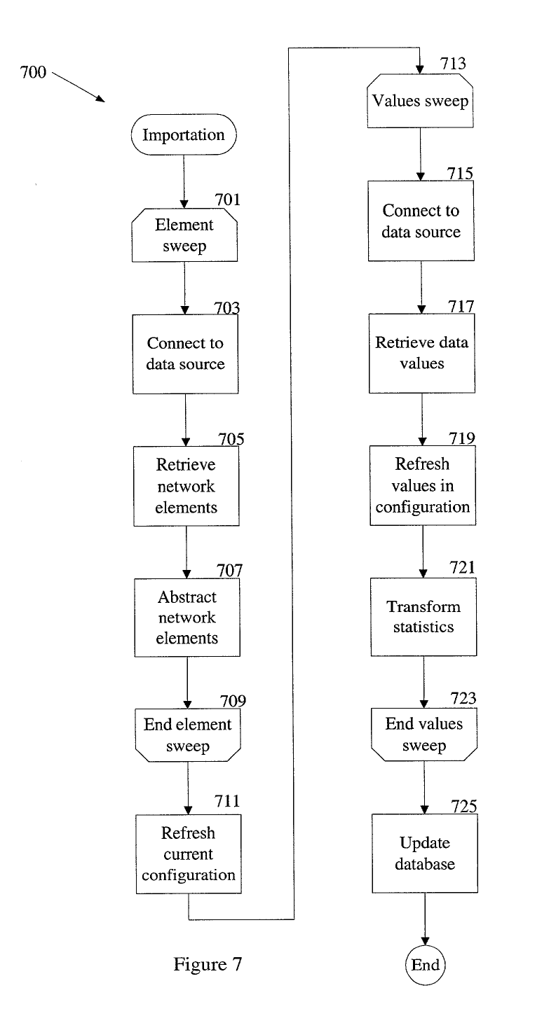

In the particular embodiment shown in FIG. 3, multiple data drivers 301 within the DAIE 201 map data elements from the different data sources 101 into a data model 303 that represents a common abstraction of data that is stored and used by an importation analysis engine 305. The importation analysis engine 305 compares the data elements in the data model 303 to corresponding data elements in the database management system 203 to determine changes in the data sources 101. The importation analysis engine 305 is constrained by various thresholds to prevent mis-configuration of the network in case of errors in the data from the data sources 101. For example, a threshold might be trigged if too many network elements are being marked by the importation analysis engine 305 as deleted from, or moved within, the network. Such a threshold protects the database from malfunctions coming from a data source itself. For example, if too many network elements disappear at the same time, the importation analysis engine 305 can identify this as a system malfunction and cancel the importation, rather than marking incorrectly the missing network elements as deleted. The importation analysis engine 305 also transforms statistical data obtained from the external data sources 101 into various statistics used by the application server 205. The processing performed by the components of the DAIE 201 is described in more detail in conjunction with FIG. 7 below.

Turning now to FIG. 4, each data driver 301 comprises a set of modules that perform the accessing 401, decoding 403, and mapping 405 of the data elements from the data sources. Although one data driver module may be utilized by multiple data drivers, the combination of access, decode, and mapping modules 401, 403, 405 are unique for each data source. Thus, as shown in FIG. 4, the data driver for database 107 comprises DB access module 407, decode module1 413, and mapping module1 417, while the data driver for table 109 comprises table access module 409, decode module2 415, and mapping module2 419. The different data driver components are coupled together as described by metadata tables 427 in the data model 303 so that modification of a single module need only affect those data drivers that incorporate that module. In one embodiment, a class of Java “beans” that provide the functions of the access, decode, and mapping modules are stored in the metadata tables 423. The combination of modules to form a data driver is defined through a data driver tool in the set of tools 209. It will be appreciated that more or fewer modules may be used to perform the described processing of the data drivers without exceeding the scope of the invention.

Each access module defines the network location, direct connection, and retrieval commands necessary to retrieve the data values from a particular data source, such as attributes, statistics and alarms. Each decode module 403 defines what type of decoding, such as parsing, decompression or decryption, that must be performed on the data values to convert them into a decoded form. The mapping modules 405 map the decoded data values into abstracted data tables 425 in the data model 303 with reference to the metadata tables 423, resolving any differences between the characteristics of the input data elements and the characteristics of the abstracted data 425. For example, a data source might use three fields to define a data element that is defined using only two fields in the abstracted data tables 425. The metadata tables 423 relate the input data elements from the different data sources to the abstracted data tables 425 that define a unified view of the network data. It will be appreciated that although the metadata 423 and abstracted data 425 are described as tables, any type of data structure can be used to hold their data.

In the particular embodiment being described, the abstracted data tables 425 are created once for all data elements in the system and require no modification to accommodate vendor or network changes. Instead, changes in the data from the data sources are reflected in the metadata tables 423 to map the changed data into the correct location in the abstracted data tables 425. As shown in FIG. 4, table 109 contains two different versions of data that require the mapping module2 419 to refer to two different metadata tables, 427 and 429. This situation would arise, for example, when the network is running two different versions of the same software, resulting in different data elements being stored in the table 109. When the second version is added, the metadata table2 429 is created from the metadata table1 427 by adding new rows that map the new/changed data into the abstracted data table 425. Alternatively, dormant rows in metadata table 1 427 could be activated for the new/changed data to eliminate the need to have two different metadata tables that are slightly different. Detection of which metadata tables 423 should be used by the mapping modules 405 can be performed by any of the modules in the data driver when a version identifier is included in the data or as part of the property definition of the data in the software configuration structure for the network. By creating a version metadata table (not shown) that relates version identifiers and data sources, a change in version can also be detected as part of the initial analysis of the network by the importation analysis engine 305. For example, in a telecommunications network, each OMC (Operations and Maintenance Center) only manages network data sources executing a specific software version. Therefore, when the importation analysis engine 305 detects the source of the data for the source has changed from a first OMC to a second OMC, it uses the version metadata table to determine which version is managed by the second OMC and consequently what version is being executed by the data source.

Thus, the metadata tables 423 provide another level of abstraction that make the data model 303 extensible, dynamically configurable, and self-describing. The data model 303 is extensible because the mappings of input data into the abstracted data tables 425 defined by the metadata tables 423 are updated with changes in the input data. The data model 303 is dynamically configurable in that the metadata tables 423 can be defined as changeable and require a single human intervention to support the co-existence of multiple versions of the network data. In a “classic” (non data-driven) software system, the software is built on top of a data model and depends on it. Any change in the data model requires a change in the software system. Moreover, changes in the data model require strong development and database administration skills. The dynamically adaptive importation engine is designed to accommodate any change in the metadata without having to be adapted.

The DAIE also provide tools to changes those metadata easily, without any particular software/database skills. A metadata tool in the tools 209 is used to manually configure the metadata tables 423. The metadata tool includes a data explorer that uses the data driver specific to a particular data source to discover the data structure of the data from that source. For example, data in the flat file 111 is in a list structure while data in the database 107 is in rows and columns.

Returning now to FIG. 3, once the importation analysis engine 305 in the DAIE 201 has finished its analysis of the abstracted data, it invokes a database engine 307 in the database system 203 to update the database for the network. As shown in FIG. 3, the database is divided into two different types of databases: a relational database 309 and a multi-dimensional database 311. The database engine 307 controls what data is stored in which database based on characteristics of the input data, such as its statistics (ex., volume, fixed/changing values) and retrieval requirements (ex., simultaneously access a range of data for aggregation purposes). Other data characteristics that can be used to determine the appropriate data will be immediately perceived by one of skill in the art and are considered within the scope of the invention. The database engine 307 can accommodate requests for data of a different granularity than stored in the databases 309, 311 by combining existing fields and choosing among multiple possibilities based on speed and availability of the data using the formulas input through the formula editor that is part of the tools 209.

In an alternate embodiment not shown, the database engine 307 includes data management modules specific to each database that handle the storing and retrieving of data from the databases 309, 311. A software layer also may be incorporated into the database engine 307 to translate between the commands particular to the underlying databases and the set of commands native to the database engine 307.

Any well-known relational database is suitable for use as the relational database 309. In the embodiment shown in FIG. 3, the multi-dimensional database 311 is based on a cube data structure, such as commonly used in multi-dimensional online analytic processing (MOLAP) to provide fast access to summaries of data from different view points. As illustrated in FIG. 5, data elements 503 are stored as a linear physical array 501 in a file. The array 501 can be logically mapped to a conceptual three-dimension cube 505 by converting the linear position of each data element 503 within the file, i.e., position 0, 1, . . . , filesize-1, into a set of three coordinates (x, y, z) along the cube axes. In one embodiment, a mapping is chosen that maximizes performance at insertion time to obtain a near-to-real time system, while keeping good overall performance at retrieval time. The array 501 does not require use of indexes, as each data element 503 is identified by its linear position in the file.

For example, in a wireless telecommunications network, the axes of the cube 505 may be cell location, amount of traffic, and time, while the values of the data elements 503 could be the number of dropped calls. The amount of traffic axis could be a set of ranges of finer and finer granularity, and the time axis could be divided into finer and finer elapsed time granularities to provide the user with both a summary view of the problem of dropped calls in the network and the ability to “drilldown” to the finer details to further focus in on the problem. Several “pre-aggregated” cubes at different granularities can coexist in the database; the correlation engine determines which has the proper granularity required to obtain the level of detail requested by the user, while maximizing data extraction performance.

Once the data is stored in the databases 309, 311, it can be retrieved through the database engine 307 by a correlation engine 313 within the application server 205. The correlation server 313 correlates the data from the multiple sources to create information for the entire network that is presented to the user through one or more presentation formats 315. A knowledge engine 317 within the application server 205 further analyzes the information created by the correlation engine 313 using a library of scenarios 319. The user applications 207 interface with the correlation engine 313 and the knowledge engine 317 through a set of pre-defined application program interfaces (APIs) 321.

The presentation formats 315 may combine different forms of presentation such as simultaneously displaying a map based on GIS data for the network elements from the relational database 309, a textual report containing an aggregated error rate over a certain time period for the network elements from the multi-dimensional database 311, and graphical depictions (ex.: bar/line charts) dynamically created from the GIS data and aggregation. The correlation report builder provided in the tools 209 allows the user to design the desired presentations as templates that are stored in a library for later use by the correlation engine 313.

Each scenario in the library 319 defines a relationship between reports and analysis modules that embody expert knowledge of how to identify and handle problems disclosed by the reports. When a report is presented to the user by the correlation engine 313, the user may choose to invoke the knowledge engine 317 to analyze the information in the report. The knowledge engine 317 determines which scenario is associated with the report and executes the corresponding analysis module, passing in the report information. In one embodiment, records in the scenario library 319 to specify the relationships between the reports and scenarios.

The analysis module is a script that controls which additional report will be presented based on the information in the reports and user input. Each analysis module is designed around three functions: 1) analysis of the report information; 2) presentation of text to the user to explain the results of the analysis; and 3) suggestion of a problem resolution or a further report to execute to provide more details. When multiple reports are potentially useful, the importation analysis engine presents them in a list ordered on their relevance.

At an intermediate customization level, the behavior of the analysis modules can be tuned by setting module-specific parameters, typically thresholds. In an embodiment that uses Java bean technology to write the scripts, the analysis module can easily and concisely accept those parameters. The tuning of the analysis modules enables the building and refining of the scenarios by advanced, but non-programmer users, allowing the scripts to be user-configurable through a GUI without intervention of the script writer.

The analysis module also passes to the knowledge engine 317 the present information that is identified as problematic for use in constructing the next report. The scheduler in the DAIE 201 can execute the knowledge engine 317 as part of the batch processing of data. When executing in batch mode, an analysis module may raise an alarm instead of presenting a suggested report or reports.

Each scenario can be represented as a directed-graph data structure 600 as shown in FIG. 6, in which the circles (graphical nodes) represent the analysis modules associated with the scenario and the arrows (edges) represent the possible reports. When a user viewing report N invokes the knowledge engine 317, the knowledge engine 317 executes the analysis module at graphical node 601 to begin the scenario associated with report N. The analysis module at graphical node 601 evaluates the information in the report N and determines whether to take edge 602 or 610 based on the results. The analysis modules can also factor in user input, such as when multiple edges may be equally valid, to determine the appropriate edge to take. Assuming edge 602 is appropriate, the analysis module at graphical node 601 instructs the knowledge engine 317 to present the report associated with edge 602, which causes the knowledge engine 317 to execute the analysis module at graphical node 603. The analysis modules at graphical node 603 determines whether to take edge 604, 606, or 608 based on the information in the corresponding report. The sequence would then continue with the reports and analysis modules associated with either edge 604/graphical node 604, edge 606/graphical node 607, or edge 608/graphical node 609. Similarly, if edge 610 had been indicated by the analysis module at graphical node 601, the knowledge engine 317 would have presented the report associated with edge 610 and executed the analysis module at graphical node 611 to determine if the next report in sequence would be that associated with edge 612 or with edge 614. If edge 614 is taken, the analysis at graphic node 613 may produce a report at edge 616 that is analyzed by the module at graphical node 609, or may result in graphical node 613 acting as an end graphical node. When the knowledge engine 317 executes an analysis module at an end graphical node of the directed-graph 600, the user is presented with a suggested action to take to solve the problem. The user can direct the knowledge engine 317 to terminate the scenario at any graphical node in the directed-graph 600. Thus, the execution sequence of reports is not fixed in a scenario because the linkage between the current graphical node and the next is only determined at the time the analysis module at the current graphical node evaluates the corresponding report. Because of the flexibility of the scenarios to react to different input, they can also be used to perform “what-if” analysis on potential changes in the network, as well as supporting the creation of completely new network services.

In one embodiment, the scenario library 319 contains a set of Java beans. Each bean causes a particular report to be presented and performs the analysis of the report. Each bean also defines its relationship to other beans based on instruction clauses, with a group of inter-related beans defining the possible report sequences for the scenario. The pre-programmed beans can be adapted as desired by the user through the scenario builder in the tools 209.

### Methods of the Invention

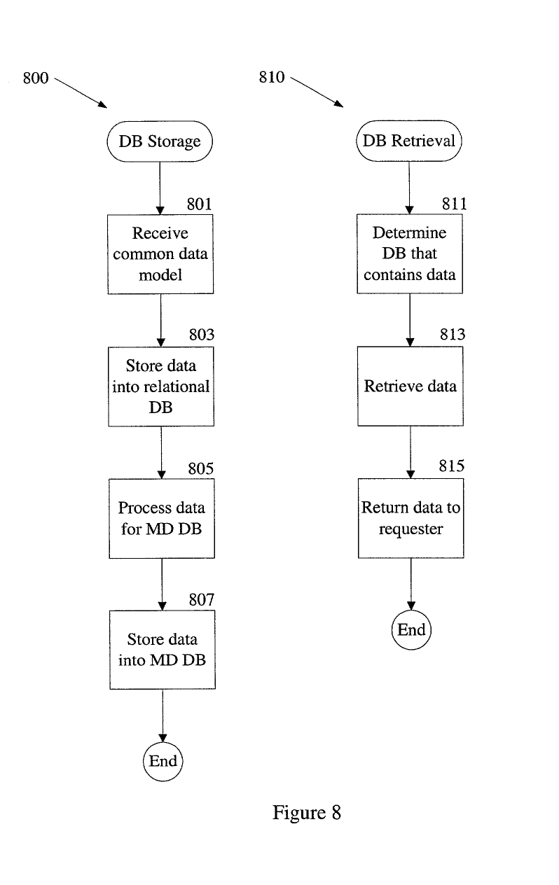

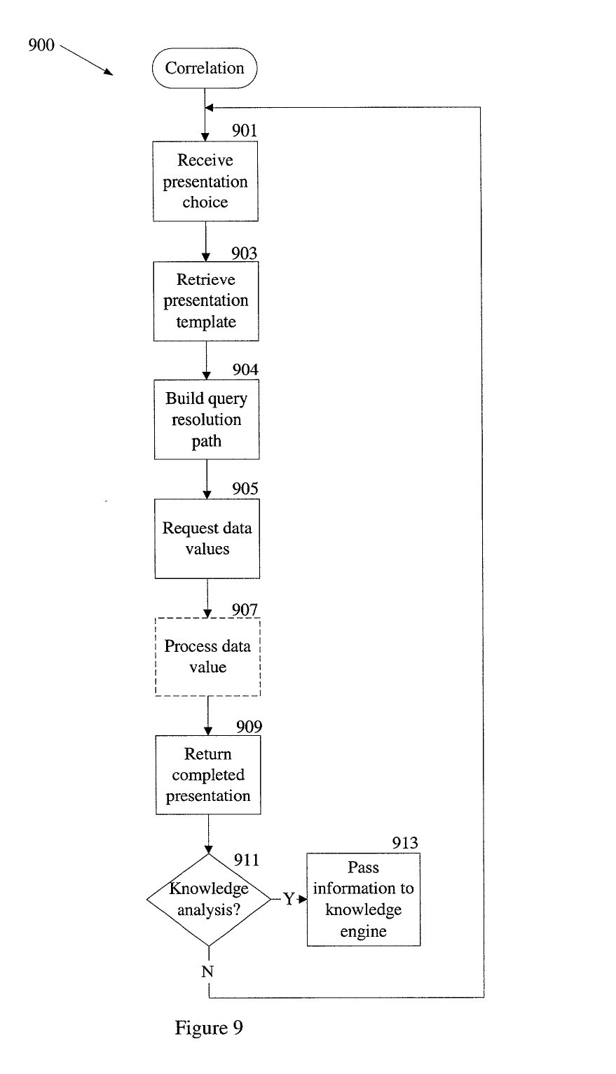

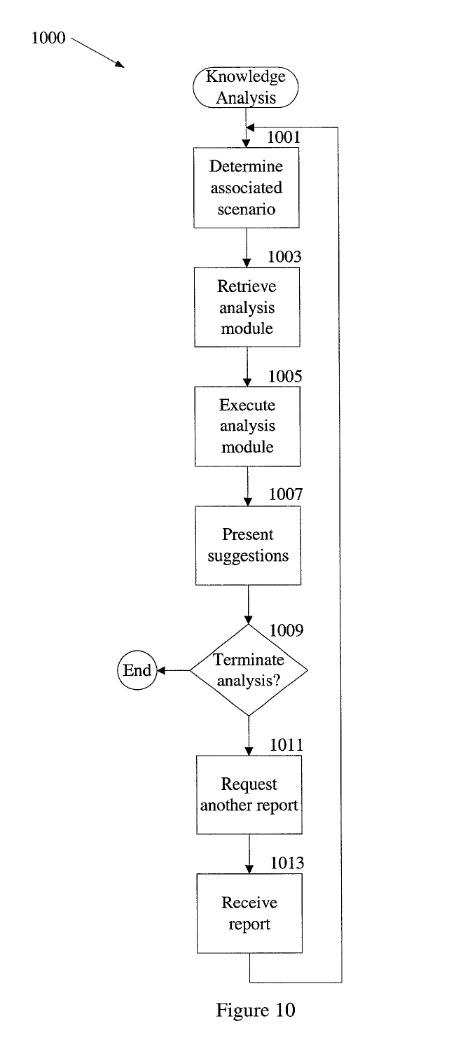

Next, methods to be performed by the modules described in the previous section are described in terms of computer software with reference to flowcharts shown in FIGS. 7-10. The methods constitute computer programs made up of computer-executable instructions illustrated as blocks (acts), including all the acts from 701 until 725 in FIG. 7, from 801 until 815 in FIG. 8, from 901 until 913 in FIG. 9, and 1001 until 1013 in FIG. 10. Describing the methods by reference to a flowchart enables one skilled in the art to develop such programs including such instructions to carry out the methods on suitably configured computers (the processing unit of the computer executing the instructions from computer-readable media). The computer-executable instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result. It also will be appreciated that more or fewer processes may be incorporated into the methods illustrated in FIGS. 7-10 without departing from the scope of the invention and that no particular order is implied by the arrangement of blocks shown and described herein.

One embodiment of an importation method 700 that can be performed by a computer to provide the functions of the DAIE 201 is illustrated in FIG. 7. The importation method 700 operates in three phases. The data drivers 301 “sweep” through all the network elements to create the abstraction of the current network configuration, illustrated as a processing loop starting at block 701 and ending at block 709, including connecting to each data source (block 703), retrieving the network elements associated with each data source (block 705), and mapping the network elements into the common data model 303 for further processing (block 707). The importation analysis engine 305 refreshes the network configuration at block 711 by comparing the current network configuration against the previous configuration. The processing at block 711 is designed to detect changes in the network, such as the addition and deletions of network elements, software versions updates of the network elements, and to determine which changes are valid and which are the symptoms of network problems. After the network configuration has been refreshed, the data drivers 301 sweep through the data values from the network, illustrated as a processing loop starting at block 713 and ending at block 723. The values sweep connects to each data source (block 715), retrieves the data values from each data source (block 717), and refreshes the current configuration in the common data model 303 with the data values (block 719). The importation analysis engine 305 transforms statistical data values from the data sources to produce various network statistics used by the correlation engine 313 and the knowledge engine 317 (block 721). At block 725, the importation analysis engine 305 invokes the database engine 307 to store the current network configuration, data values (e.g., attributes and alarms) and statistics into the databases 309, 311. In an alternate embodiment not shown, a separate sweep through the data sources is performed to collect the statistics.

When the database engine 307 is invoked by the importation analysis engine 305 at block 725, a database storage method 800 is executed to perform the operations of the database engine. The method 800 receives the common data model 303 for the current configuration (block 801), stores certain of the data elements and associated values in the relational database 309 as specified in the metadata 423 (block 803), processes those data elements and associated values that are specified for storage into the multi-dimensional database 311 to produce the aggregated values (block 805), and stores the aggregated values in the appropriate cells in the multi-dimensional database 311 (block 807).

When data stored in the databases 309, 311 is requested, such as by the correlation engine 313, a database retrieval method 810 is performed. The metadata tables 423 are used to determine which database contains the data elements and values requested (block 811), the data is retrieved (block 813), and returned to the requester (block 815).

Turning now to FIG. 9, a correlation method 900 is described that performs the operations of the correlation engine 313. The method 900 receives a choice of an information presentation format from a user applications 207 or the knowledge engine 317 (block 901), retrieves the requested presentation format template from the library (block 903), analyses the request and builds a query resolution plan (block 904), requests the appropriate data values from the database engine 307 (block 905), and processes the data values as necessary to produce the granularity of information specified by the formulas in the format template (block 907, shown in phantom). The complete presentation is returned to the requester at block 909.

At block 911, the method 900 determines if input from the user is a request to run a knowledge analysis on the information in a currently presented report. If so, the information is passed to the knowledge engine 317 at block 913. In either case, the method 900 loops back to block 901 to receive another presentation choice. It will be appreciated that the choice received at block 901 may be for a different presentation or for further details for the current presentation.

When the knowledge engine 317 is invoked at block 913, a knowledge analysis method 1000 is executed as illustrated in FIG. 10. The method 1000 determines what scenario is associated with the current report (block 1001), retrieves the corresponding analysis module from the scenario library 319 (block 1003), executes the analysis module (block 1005), and presents one or more suggestions to the user (block 1007). Based on the user input (block 1009) and the results of the analysis modules, the method 1000 terminates or requests another report from the correlation engine (block 1011), receives the report (block 1013), and loops to block 1001 to continue the analysis.

### Operating Environment

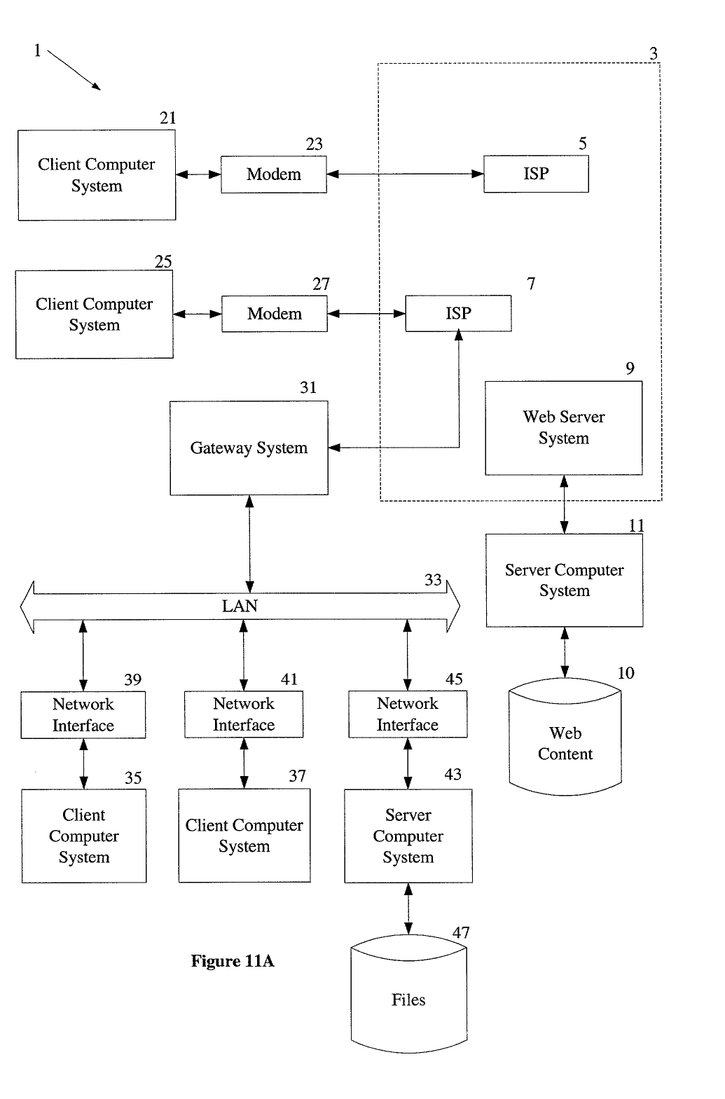

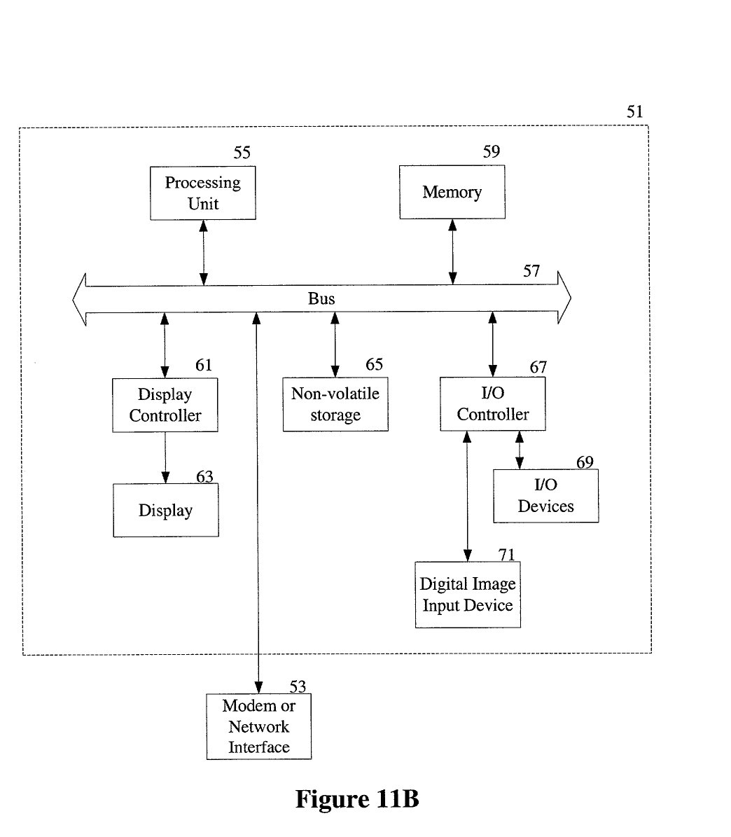

The following description of FIGS. 11A-B is intended to provide an overview of computer hardware and other operating components suitable for performing the methods of the invention described above, but is not intended to limit the applicable environments. One of skill in the art will immediately appreciate that the invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network having a physical or wireless infrastructure, or a combination of both.

FIG. 11A shows several computer systems that are coupled together through a network 3, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet 3 is typically provided by Internet service providers (ISP), such as the ISPs 5 and 7. Users on client systems, such as client computer systems 21, 25, 35, and 37 obtain access to the Internet through the Internet service providers, such as ISPs 5 and 7, through either physical or wireless interfaces. Access to the Internet allows users of the client computer systems to exchange information, receive and send e-mails, and view documents, such as documents which have been prepared in the HTML format. These documents are often provided by web servers, such as web server 9 which is considered to be “on” the Internet. Often these web servers are provided by the ISPs, such as ISP 5, although a computer system can be set up and connected to the Internet without that system being also an ISP as is well known in the art.

The web server 9 is typically at least one computer system which operates as a server computer system and is configured to operate with the protocols of the World Wide Web and is coupled to the Internet. Optionally, the web server 9 can be part of an ISP which provides access to the Internet for client systems. The web server 9 is shown coupled to the server computer system 11 which itself is coupled to web content 10, which can be considered a form of a media database. It will be appreciated that while two computer systems 9 and 11 are shown in FIG. 11A, the web server system 9 and the server computer system 11 can be one computer system having different software components providing the web server functionality and the server functionality provided by the server computer system 11 which will be described further below.

Client computer systems 21, 25, 35, and 37 can each, with the appropriate web browsing software, view HTML pages provided by the web server 9. The ISP 5 provides Internet connectivity to the client computer system 21 through the modem interface 23 which can be considered part of the client computer system 21. The client computer system can be a personal computer system, a network computer, a Web TV system, handheld wireless device or other such computer system. Similarly, the ISP 7 provides Internet connectivity for client systems 25, 35, and 37, although as shown in FIG. 11A, the connections are not the same for these three computer systems. Client computer system 25 is coupled through a modem interface 27 while client computer systems 35 and 37 are part of a LAN. While FIG. 11A shows the interfaces 23 and 27 as generically as a “modem,” it will be appreciated that each of these interfaces can be an analog modem, ISDN modem, cable modem, satellite transmission interface (e.g. “Direct PC”), radio frequency (RF), cellular, or other interfaces for coupling a computer system to other computer systems. Client computer systems 35 and 37 are coupled to a LAN 33 through network interfaces 39 and 41, which can be Ethernet network or other network interfaces. The LAN 33 is also coupled to a gateway computer system 31 which can provide firewall and other Internet related services for the local area network. This gateway computer system 31 is coupled to the ISP 7 to provide Internet connectivity to the client computer systems 35 and 37. The gateway computer system 31 can be a conventional server computer system. Also, the web server system 9 can be a conventional server computer system.

Alternatively, as well-known, a server computer system 43 can be directly coupled to the LAN 33 through a network interface 45 to provide files 47 and other services to the clients 35, 37, without the need to connect to the Internet through the gateway system 31.

FIG. 11B shows one example of a conventional computer system that can be used as a client computer system or a server computer system or as a web server system. It will also be appreciated that such a computer system can be used to perform many of the functions of an Internet service provider, such as ISP 5. The computer system 51 interfaces to external systems through the modem or network interface 53. It will be appreciated that the modem or network interface 53 can be considered to be part of the computer system 51. This interface 53 can be an analog modem, ISDN modem, cable modem, token ring interface, satellite transmission interface (e.g. “Direct PC”), radio frequency (RF), cellular, or other interfaces for coupling a computer system to other computer systems. The computer system 51 includes a processing unit 55, which can be a conventional microprocessor such as an Intel Pentium microprocessor or Motorola Power PC microprocessor. Memory 59 is coupled to the processor 55 by a bus 57. Memory 59 can be dynamic random access memory (DRAM) and can also include static RAM (SRAM).The bus 57 couples the processor 55 to the memory 59 and also to non-volatile storage 65 and to display controller 61 and to the input/output (I/O) controller 67. The display controller 61 controls in the conventional manner a display on a display device 63 which can be a cathode ray tube (CRT) or liquid crystal display. The input/output devices 69 can include a keyboard, disk drives, printers, a scanner, and other input and output devices, including a mouse or other pointing device. The display controller 61 and the I/O controller 67 can be implemented with conventional well known technology. A digital image input device 71 can be a digital camera which is coupled to an I/O controller 67 in order to allow images from the digital camera to be input into the computer system 51. The non-volatile storage 65 is often a magnetic hard disk, an optical disk, or another form of storage for large amounts of data. Some of this data is often written, by a direct memory access process, into memory 59 during execution of software in the computer system 51. One of skill in the art will immediately recognize that the term “computer-readable medium” includes any type of storage device that is accessible by the processor 55 and also encompasses a carrier wave that encodes a data signal.

It will be appreciated that the computer system 51 is one example of many possible computer systems which have different architectures. For example, personal computers based on an Intel microprocessor often have multiple buses, one of which can be an input/output (I/O) bus for the peripherals and one that directly connects the processor 55 and the memory 59 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 59 for execution by the processor 55. A Web TV system, which is known in the art, is also considered to be a computer system according to the present invention, but it may lack some of the features shown in FIG. 11B, such as certain input or output devices. A typical computer system will usually include at least a processor, memory, and a bus coupling the memory to the processor.

It will also be appreciated that the computer system 51 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. The file management system is typically stored in the non-volatile storage 65 and causes the processor 55 to execute the various acts required by the operating system to input and output data and to store data in memory, including storing files on the non-volatile storage 65.

### Conclusion

A layered architecture for a network information management system has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

For example, those of ordinary skill within the art will appreciate that any arrangement of modules that achieve the same result as the arrangements described herein are within the scope of the invention. Furthermore, those of ordinary skill within the art will appreciate the particular embodiments of the invention described as using Java technology do not limit the invention.

The terminology used in this application with respect to networks is meant to include environments in which network equipment from different vendors operate in conjunction with one another. Therefore, it is manifestly intended that this invention be limited only by the following claims and equivalents thereof.

What is claimed is:

1. A computerized method of integrating data from disparate sources in a network comprising:
importing the data from the disparate sources;
mapping the data into a common data model;
storing the data in the common data model into a storage structure based on characteristics of the data;
correlating the data in the storage structure to produce information about the network; and
presenting the information to provide a unified view of the network.

2. The computerized method of claim 1 further comprising:
performing a knowledge analysis on the information to evaluate the network using a knowledge scenario.

3. The computerized method of claim 2, wherein the knowledge scenario detects a problem in the network suggests a solution to the problem.

4. The computerized method of claim 3, wherein the knowledge scenario defines a relationship between the information and an analysis process that detects the problem and determines the solution.

5. The computerized method of claim 2, wherein the knowledge scenario defines a relationship between the information and an analysis process that evaluates the network.

6. The computerized method of claim 1 further comprising:
changing the mapping of the data in accordance with changes in the disparate sources.

7. The computerized method of claim 1, wherein the storage structure comprises an multi-dimensional database, and further comprising aggregating the data to produce values to be stored in the multi-dimensional database.

8. The computerized method of claim 1 further comprising:
transforming network statistics obtained from the disparate sources; and
storing the transformed network statistics in the storage structure.

9. The computerized method of claim 1, wherein correlating the data comprises:
selecting a presentation format from a plurality of presentation formats;
retrieving the data from the storage structure required by the presentation format; and
processing the data from the storage structure as necessary to produce the presentation format.

10. The computerized method of claim 9, wherein the data required by the presentation format is selected from the group consisting of text, graphical and geographical data.

11. A computer-readable medium having executable instructions to cause a computer to execute a method of integrating data from disparate sources in a network, the method comprising:
importing the data from the disparate sources;
mapping the data into a common data model;
storing the data in the common data model into a storage structure based on characteristics of the data;
correlating the data in the storage structure to produce information about the network; and
presenting the information to provide a unified view of the network.

12. The computer-readable medium of claim 11, wherein the method further comprises:
performing a knowledge analysis on the information to evaluate the network using a knowledge scenario.

13. The computer-readable medium of claim 12, wherein the knowledge scenario detects a problem in the network suggests a solution to the problem.

14. The computer-readable medium of claim 13, wherein the knowledge scenario defines a relationship between the information and an analysis process that detects the problem and determines the solution.

15. The computer-readable medium of claim 12, wherein the knowledge scenario defines a relationship between the information and an analysis process that evaluates the network.

16. The computer-readable medium of claim 11, wherein the method further comprises:
changing the mapping of the data in accordance with changes in the disparate sources.

17. The computer-readable medium of claim 11, wherein the storage structure comprises an multi-dimensional database, and further comprising aggregating the data to produce values to be stored in the multi-dimensional database.

18. The computer-readable medium of claim 11, wherein the method further comprises:
transforming network statistics obtained from the disparate sources; and
storing the transformed network statistics in the storage structure.

19. The computer-readable medium of claim 11, wherein correlating the data comprises:
selecting a presentation format from a plurality of presentation formats;
retrieving the data from the storage structure required by the presentation format; and
processing the data from the storage structure as necessary to produce the presentation format.

20. The computer-readable medium of claim 19, wherein the data required by the presentation format is selected from the group consisting of text, graphical and geographical data.

21. A computer-readable medium having computer-executable components for a layered management architecture for a network comprising:
an dynamically adaptive importation engine communicatively coupled to a plurality of disparate sources of network data to import the network data from the disparate sources and to map the network data into abstracted data in a common data model that represents a unified view of the network;
a database system communicatively coupled to the dynamically adaptive importation engine to store the abstracted data from the common data model into a database and to retrieve the abstracted data from the database; and
an application server communicatively coupled to the database system to correlate the abstracted data retrieved from the database by the database module into information for the network and to present the information in a particular format.

22. The computer-readable medium of claim 21, wherein the dynamically adaptive importation engine comprises:
a plurality of data drivers, each data driver communicatively coupled to a particular source to import and map the data from the particular source into the abstracted data in the common data model; and
an importation analysis engine communicatively coupled to the common data module to process the abstracted data to determine changes in the particular source and to transform statistics from the particular source.

23. The computer-readable medium of claim 22, wherein each of the plurality of data drivers comprises:
an access module communicatively coupled to the particular data source to obtain the data from the particular source; and
a mapping module communicatively coupled to the access module to map the data from the particular source to the abstracted data in the common data model.

24. The computer-readable medium of claim 23 further comprising a decode module communicatively coupled to the access module and further communicatively coupled to the mapping module to decode encoded data from the particular source.

25. The computer-readable medium of claim 23, wherein the common data model comprises metadata that specifies mappings between the data from the disparate sources and the abstracted data in the common data model.

26. The computer-readable medium of claim 21, wherein the database system comprises a database engine to receive commands from the dynamically adaptive importation engine and from the application server, and to execute the commands on the database.

27. The computer-readable medium of claim 26, wherein the database comprises a relational database and a multi-dimensional database and wherein the database engine determines in which database to store the abstracted data and from which database to retrieved the abstracted data.

28. The computer-readable medium of claim 21, wherein the application server comprises a correlation engine communicatively coupled to the database system and to a plurality of formats to select the particular format, to request required abstracted data for the particular format from the database server, and to process the abstracted data if necessary to produce the particular format.

29. The computer-readable medium of claim 28, wherein the application server further comprises a knowledge engine communicatively coupled to the correlation engine and to a library of scenarios to process the abstracted data for the particular format according to a scenario associated with the particular format to evaluate the network.

30. The computer-readable medium of claim 29, wherein the knowledge engine further detect a problem in the network and suggests a solution to the problem as specified by the scenario associated with the particular format.

31. A computer-readable medium having stored thereon an scenario data structure for a network having disparate data sources comprising:
an analysis module containing computer-executable instructions to evaluate network information in a first presentation format associated with the analysis module; and
a relationship field defining a relationship between a result produced by the analysis module and a second presentation format that presents further network information.

32. A computer-readable medium of claim 31, wherein the result is a detection of a network problem and the second presentation format suggests a solution to the problem.

33. A computerized system comprising:
a processing unit coupled to a memory through a bus and further operable for coupled to a plurality of disparate sources that supply data about a network;
an integration and configuration manager process executed from the memory by the processing unit to cause the processing unit to import the data from the disparate sources and to map the data into a common data model;
a database engine process executed from the memory by the processing unit to cause the processing unit to store the data in the common data model into a database and to retrieve the data from the database; and
an application server process executed from the memory by the processing unit to cause the processing unit to correlate the data retrieved from the database to produce information about the network and to present the information to provide a unified view of the network.

34. The computerized system of claim 33, wherein the application server process further causes the processing unit to perform a knowledge analysis on the information to evaluate the network using a knowledge scenario read from the memory.

35. The computerized system of claim 34, wherein application server process further causes the processing unit to detect a problem in the network and to determine a solution to the problem based on the knowledge scenario.
